(19) United States
(12) Patent Application Publication
(10) Pub. No.: US 2010/0296903 A1
(43) Pub. Date: Nov. 25, 2010

(54) END EFFECTOR FOR HANDLING SUBSTRATES

(75) Inventors: VINAY K. SHAH, San Mateo, CA (US); Navdeep Gupta, Vinayak Nagar (IN); Satish Sundar, Bangalore, CA (US); Andrea Baccini, Treviso (IT); Christopher Burkhart, Los Gatos, CA (US); Rohit Dey, Brookefield (IN); Christian Zorzi, Treviso (IT)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/769,486

(22) Filed: Apr. 28, 2010

Related U.S. Application Data
(60) Provisional application No. 61/173,856, filed on Apr. 29, 2009.

(30) Foreign Application Priority Data
Nov. 24, 2009 (IT) UD2009A000214

(51) Int. Cl. B65G 47/91; B25J 15/06; B25J 11/00

(52) U.S. Cl. 414/589; 294/64.1; 414/800; 901/40

(57) ABSTRACT

Embodiments of the present invention provide an end effector for a substrate handling robot. In one embodiment, the end effector comprises one or more Bernoulli chucks surrounded by a plurality of suction cup devices. In one embodiment, the suction cup devices are configured in the form of a bellows to provide both cushioning and lateral stability to the substrate. In one embodiment, the suction cup devices further include an air pressure device to provide light positive pressure to the substrate during release. Embodiments of the end effector described herein provide a small vacuum pressure over a large area of ultra-thin substrates to minimize damage during handling.

### CROSS-REFERENCE TO RELATED APPLICATIONS

This application claims benefit of U.S. Provisional Patent Application Ser. No. 61/173,856 (APPM/014354L), filed Apr. 29, 2009, which is herein incorporated by reference.

### BACKGROUND OF THE INVENTION

1. Field of the Invention

Embodiments of the present invention generally relate to an apparatus and method that may be used in forming solar cell devices. In particular, embodiments of the present invention provide a robot with an end effector for handling solar cell substrates in an automated fashion.

2. Description of the Related Art

Solar cells are photovoltaic devices that convert sunlight directly into electrical power. The most common solar cell material is silicon, which is in the form of single or multicrystalline substrates, sometimes referred to as wafers. Because the amortized cost of forming silicon-based solar cells to generate electricity is higher currently higher than the cost of generating electricity using traditional methods, it is desirable to reduce the cost to form solar cells.

Further, as the demand for solar cell devices continues to grow, there is a need to reduce the cost of ownership (COO) of solar cell fabrication equipment by increasing the substrate throughput. Additionally, because solar cell substrates are becoming increasingly thinner (e.g., 0.15-0.30 mm or less), it is desirable to improve handling apparatus and methods to minimize incidents of substrate breakage caused by traditional substrate handling as well.

Thus, apparatus and methods for handling solar cell substrates are needed to increase substrate throughput, minimize substrate breakage, and improve device yield while minimizing the space needed in a solar cell fabrication facility.

### SUMMARY OF THE INVENTION

In one embodiment of the present invention, an end effector for a substrate transferring robot comprises one or more Bernoulli chucks, a first air control valve in fluid communication with the one or more Bernoulli chucks, and a plurality of suction cups disposed adjacent the one or more Bernoulli chucks.

In another embodiment, a method for transferring a substrate comprises maneuvering an end effector of a robot over the substrate, attracting the substrate toward the end effector via one or more Bernoulli chucks attached to the end effector, laterally stabilizing the substrate via a plurality of suction cups, maneuvering the end effector to a delivery position, and releasing the substrate.

In yet another embodiment of the present invention, a transfer robot comprises an upper base portion, one or more arm devices connected to the base portion, and an end effector connected to the one or more arm devices, wherein the end effector comprises one or more Bernoulli chucks, a first air control valve in fluid communication with the one or more Bernoulli chucks, and a plurality of suction cups disposed adjacent the one or more Bernoulli chucks.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic isometric view of a substrate loading module used in an automated solar cell production line according to one embodiment.

FIG. 2 is a schematic side view of an end effector of the robot having positioned a substrate in a pocket of the substrate carrier.

FIG. 3 is a schematic side view of an end effector holding a substrate over the vision system.

FIG. 4A is a schematic, isometric view of one embodiment of an end effector illustrating the underside thereof.

FIG. 4B is a schematic, bottom view of the end effector in FIG. 4A, illustrating the positioning of a substrate held thereby.

FIG. 5A is a schematic, isometric view of another embodiment of an end effector.

FIG. 5B is a schematic, top view of the end effector depicted in FIG. 5A.

FIG. 5C is a schematic, cross-sectional view of the end effector from FIG. 5A taken about the line C-C in FIG. 5B.

FIG. 5D is a schematic, isometric view of the end effector in FIG. 5A illustrating the underside thereof.

FIG. 5E is a schematic, bottom view of the end effector in FIG. 5A, illustrating the positioning of a substrate held thereby.

For clarity, identical reference numerals have been used, where applicable, to designate identical elements that are common between figures. It is contemplated that features of one embodiment may be incorporated in other embodiments without further recitation.

### DETAILED DESCRIPTION

Embodiments of the present invention provide an end effector for a substrate handling robot. In one embodiment, the end effector comprises one or more Bernoulli chucks surrounded by a plurality of suction cup devices. In one embodiment, the suction cup devices are configured in the form of a bellows to provide both cushioning and lateral stability to the substrate. In one embodiment, the suction cup devices further include an air pressure device to provide light positive pressure to the substrate during release. Embodiments of the end effector described herein provide a small vacuum pressure over a large area of an ultra-thin solar cell substrate to minimize damage during handling.

Generally, Bernoulli chucks create high speed airflow in an area between the chuck and a workpiece, such as a solar cell substrate. The high speed airflow creates a small pressure drop, providing a gripping force on the substrate. In operation as the substrate is drawn toward the Bernoulli chuck, the gripping force increases until it reaches an unstable point where the airflow from the chuck pushes against the substrate. At this, unstable point, the substrate flutters, which may lead to substrate breakage, particularly for ultra-thin substrates (e.g., 0.15 mm or less). Additionally, pure Bernoulli chucks do not provide lateral stability to the substrate. Therefore, a means for lateral support must accompany a Bernoulli chuck when lateral movement is necessary. Traditional concepts for laterally supporting substrates in a Bernoulli chuck include side bumpers for retaining the edges of the substrate or using a pad of high friction material between the substrate and the chuck. However, retaining bumpers tend to damage the delicate edges of ultra-thin substrates, and friction pads tend to damage substrates through impact during initial lifting.

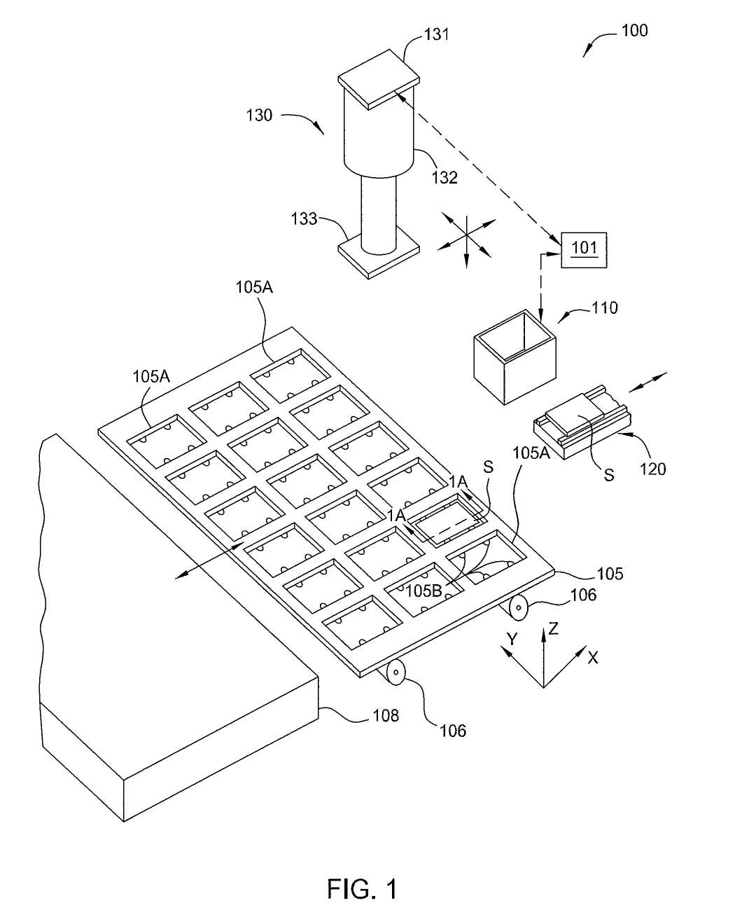

FIG. 1 is a schematic isometric view of a substrate loading module 100 used in an automated solar cell production line according to one embodiment. In one embodiment, the substrate loading module 100 includes one or more incoming conveyors 120, one or more vision systems 110, one or more transfer robots 130, a substrate carrier conveyor 106, and a system controller 101. In general operation, the transfer robot 130 first retrieves an unprocessed substrate “S” from the incoming conveyor 120. The transfer robot 130 then moves the substrate S over the vision system 110, where an image of the substrate S is captured and analyzed by the system controller 101 to determine any offset in the expected positioning of the substrate S with respect to the end effector 133. The system controller 101 may also analyze the image to determine whether the substrate S is damaged and take corrective action, such as scrapping the damaged substrate. Next, the robot 130 transfers the substrate S onto substrate pins 105B in a substrate pocket 105A in a substrate carrier 105 positioned on a carrier conveyor 106. In one embodiment, the system controller 101 adjusts the movement of the robot 130 based on the offset determined between the actual and expected positioning of the substrate S with respect to the end effector 133. Once all of the pockets 105A are filled with processed substrates S, the system controller 101 advances the substrate carrier 105 into a processing module 108 for performing a process on the substrates S.

In general, the system controller 101 is used to control one or more components and processes performed in the module 100. The system controller 101 is generally designed to facilitate the control and automation of the module 100 and typically includes a central processing unit (CPU) (not shown), memory (not shown), and support circuits (or I/O) (not shown). The CPU may be one of any form of computer processors that are used in industrial settings for controlling various system functions, substrate movement, chamber processes, process timing and support hardware (e.g., sensors, robots, motors, timing devices, etc.), and monitor the processes (e.g., chemical concentrations, processing variables, chamber process time, I/O signals, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program, or computer instructions, readable by the system controller 101 determines which tasks are performable on a substrate. Preferably, the program is software readable by the system controller 101 that includes code to perform tasks relating to monitoring, execution and control of the movement, support, and/or positioning of a substrate in the module 100. In one embodiment, the system controller 101 is used to control robotic devices to control the strategic movement, scheduling and running of the module 100 to make the processes repeatable, resolve queue time issues and prevent over or under processing of the substrates.

In one embodiment, the incoming conveyor 120 includes rollers and other components configured to transport an unprocessed substrate “S” from a downstream process in the solar cell production line. In one embodiment, the operation and timing of the incoming conveyor 120 is controlled by the system controller 101.

In one embodiment, the transfer robot 130 comprises an upper base portion 131, one or more arm devices 132, and an end effector 133. The upper base portion 131 generally includes one or more actuation devices (not shown) for moving the end effector 133 in the X, Y, and Z directions through the arm devices 132. The actuation devices may include one or more motors and/or cylinders, for instance. In one embodiment, the transfer robot 130 is a SCARA, six-axis, parallel, or linear type robot that can be adapted to transfer substrates from one position to another. In one example, the substrate transfer robot 130 is a Quattro Parallel Robot that is available from Adept Technology, Inc. of Pleasanton, Calif.

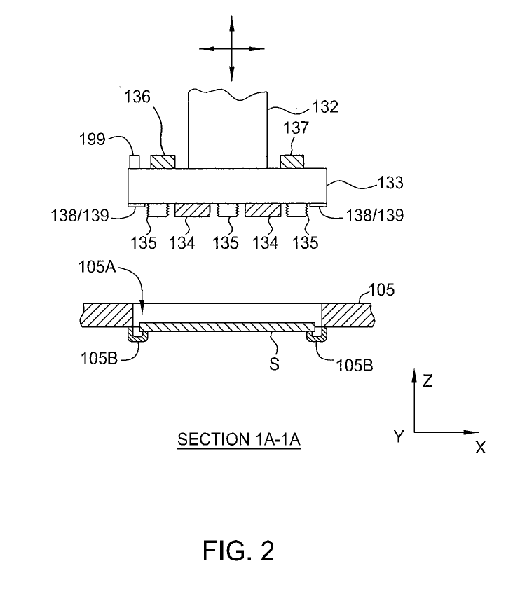

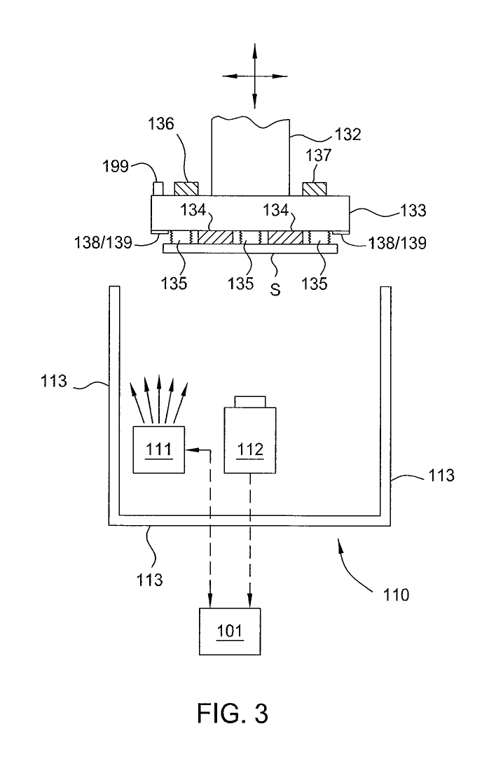

FIG. 2 is a schematic side view of one embodiment of the end effector 133 of the robot 130 having positioned a substrate S in a pocket 105A of the substrate carrier 105. FIG. 3 is a schematic side view of one embodiment of the end effector 133 holding a substrate S over the vision system 110.

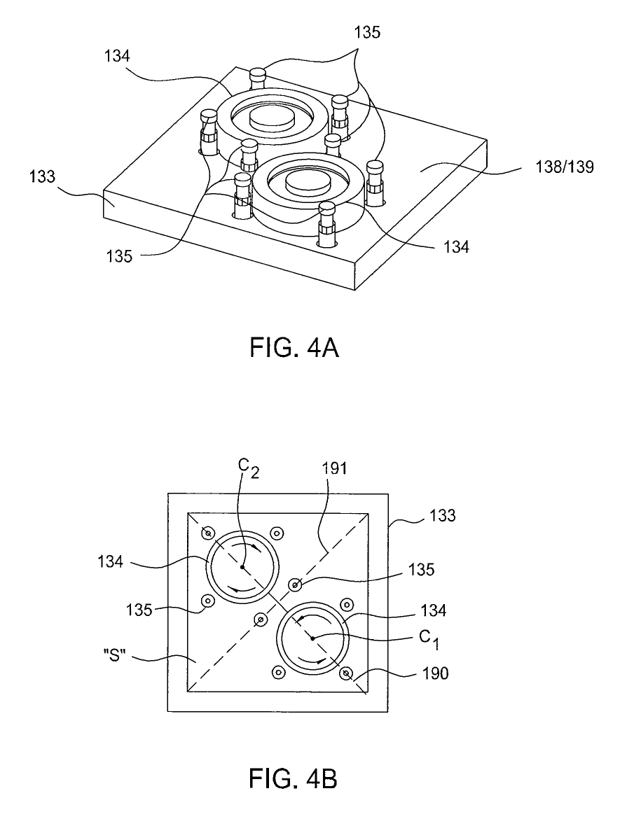

FIG. 4A is a schematic, isometric view of one embodiment of the end effector 133 illustrating the underside, or substrate receiving side, of the end effector 133. FIG. 4B is a schematic, bottom view of the end effector 133 in FIG. 4A, illustrating the positioning of a substrate S held thereby. In order to illustrate both the positioning of the substrate S held by the end effector 133 as well as the components of the end effector 133, the substrate S is depicted as being transparent. It should be noted that although FIG. 4B depicts the substrate S atop the underside of the end effector 133, in operation the end effector 133 would be oriented with the substrate S below the underside of the end effector 133, as shown in FIG. 3.

In one embodiment, the end effector 133 includes one or more Bernoulli chucks 134, a plurality of suction cups 135, and one or more first air control valves 136 in fluid communication with the Bernoulli chucks 134. In one embodiment, the end effector 133 further includes one or more second air control valves in fluid communication with the plurality of suction cups 135. The first air control valve 136, in conjunction with the system controller 101, generally controls the air flow to the Bernoulli chucks 134.

In one embodiment, the end effector 133 is configured to pick up and hold a substrate S positioned as shown in FIGS. 3 and 4B. In one embodiment, the Bernoulli chucks 134 are configured to receive gas from an air source (not shown) that is controlled by the system controller 101 using the air control valve 136. As shown by the arrows in FIG. 4B, the Bernoulli chucks 134 may be configured to cause circular air flow in opposing directions in order to prevent rotation of the substrate S. For example, the air flow generated through one Bernoulli chuck 134 may be configured to circulate in a clockwise direction, while the air flow generated through the other Bernoulli chuck 134 is configured to circulate in a counterclockwise direction.

In one embodiment, the Bernoulli chucks 134 are configured to pick up and hold a substrate S such that the center points (C1, C2) of the Bernoulli chucks 134 are intersected by a diagonal 190 connecting one set of opposing corners of the substrate S, as shown in FIG. 4B. Concurrently, a diagonal 191 connecting the other set of opposing corners of the substrate S may bisect the Bernoulli chucks 134, as shown in FIG. 4B.

In one embodiment, the end effector 133 has two 60 mm Bernoulli chucks 134 that receive gas from an air source (not shown) that is controlled by the system controller 101 using the air control valve 136. In this embodiment, the Bernoulli chucks 134 cover about 50% of a surface of a 125 mm×125 mm pseudo-square substrate and about 30% of a surface of a 156×156 mm square substrate. Since, the Bernoulli chucks 134 cover such a large area of the substrate S, the gripping force is maximized without imparting detrimental stresses into the body of the substrate.

In one embodiment, the end effector 133 includes between about 4 and about 15 suction cups 135 to both to cushion and provide lateral support to the substrate S gripped by the Bernoulli chucks 134. The suction cups 135 may be evenly distributed surrounding the one or more Bernoulli chucks 134 in order to prevent bowing in the ultra-thin substrate S, while being gripped by the Bernoulli chucks 134. In one embodiment, the suction cups 135 are configured in the general shape of a bellows to provide additional cushioning to the substrate S, particularly during retrieval of the substrate from the incoming conveyor 120. Additionally, the suction cups 135 extend beyond a lower surface of the Bernoulli chucks 134 and are configured to prevent the substrate S from moving into a region of air flow next to the Bernoulli chucks 134 that can cause detrimental fluttering of the substrate S. Thus, the suction cups 135 provide stability and cushioning to the substrate S without the detrimental drawbacks of traditional methods of stabilizing a substrate on a Bernoulli chuck.

In certain embodiments, due to the properties of the material that the suction cups 135 are made from, such as synthetic rubber materials, elastomeric materials, or other polymeric materials, the substrate S may momentarily “stick” to the suction cups 135 during release of the substrate S. This “sticking” requires the robot 130 to momentarily hesitate to safely position the substrate S before moving back to the incoming conveyor to retrieve the next substrate. In one embodiment, the second air control valve 137 is in fluid communication with the suction cups 135. The system controller 101 may signal the air control valve 137 to provide light positive air pressure through the suction cups 135 to facilitate release of the substrate S onto the substrate pins 105B in the substrate pocket 105A of the substrate carrier 105. This feature may prevent “sticking” of the substrate S on the suction cups 135 during release of the substrate S, allowing the robot 130 to move to retrieve another substrate without hesitation. Thus, this feature facilitates significantly improved substrate throughput over time. Additionally, because the first air control valve 136 and the second air control valve 137 are located at the end effector 133, a very short distance is provided between the valves 136/137 and the Bernoulli chucks 134 and suction cups 135. This results in a very short response time for retrieving and releasing substrates S, resulting in improved overall substrate throughput.

In one embodiment, the end effector 133 further includes a proximity sensor 199 attached thereto and in communication with the system controller 101. In general, the proximity sensor 199 is configured to detect the vertical relationship between the end effector 133 and the substrate pocket 105A. This relationship may be used to quickly and precisely position the end effector 133 at the appropriate elevation to deposit the substrate S into the substrate pocket 105A without damaging the substrate S.

In one embodiment, the end effector 133 is configured having a profile that facilitates quick movement over the substrate carrier 105 without disrupting the positioning of the substrate S already seated within substrate pockets 105A of the substrate carrier 105. In one embodiment, the end effector 133 has a streamline profile to reduce wake as the end effector 133 passes over the substrate carrier 105. In one embodiment, the end effector 133 has the an aerodynamic shape to prevent lift of the substrates S already positioned in substrate pockets 105A as the end effector 133 is quickly passed over the substrate carrier 105.

In one embodiment, the bottom surface 138 of the end effector 133 includes a uniform finish of appropriate color and gloss to provide a reflective background for the vision system 110. In one embodiment, the bottom surface 138 of the end effector 133 includes a backlight 139. In one embodiment, the vision system 110 includes a partial enclosure 113 containing an illumination source 111 and an inspection device 112. In one embodiment, the inspection device is a camera device. In one embodiment, the illumination source 111 is a light emitting diode (LED) source configured to emit only desired wavelengths of light (e.g., light having wavelengths in the red spectrum). In another embodiment, the illumination source 111 is a broadband light source. In one embodiment, the illumination source 111 is a broadband light source having a filter (not shown) for removing wavelengths of light in undesired ranges. Generally the system controller 101 controls the illumination source 111 and the inspection device 112. In one embodiment, the robot 130 holds the substrate S while the illumination source 111 emits light toward the substrate S and the inspection device captures one or more images of the substrate S. The system controller 101 then analyzes the image both for correction positioning and to determine whether the substrate S is damaged, as previously set forth.

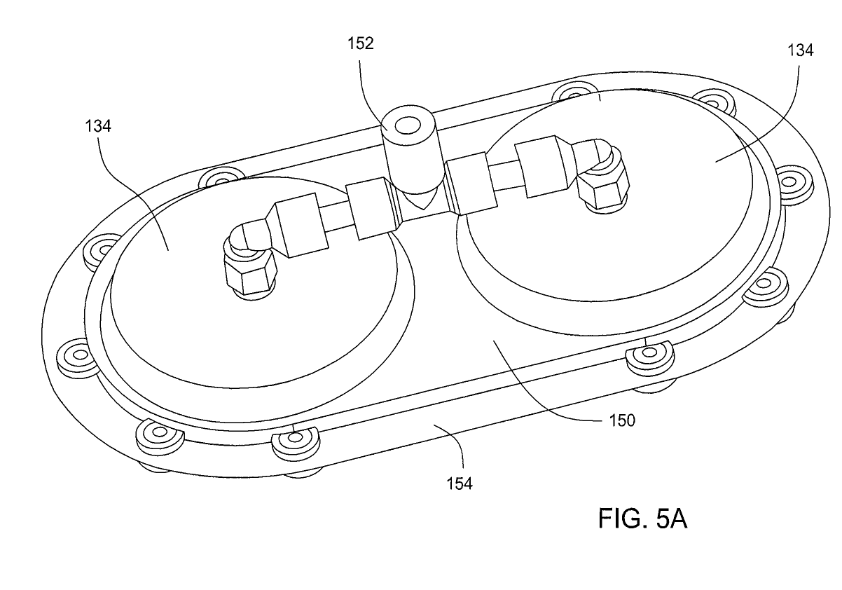

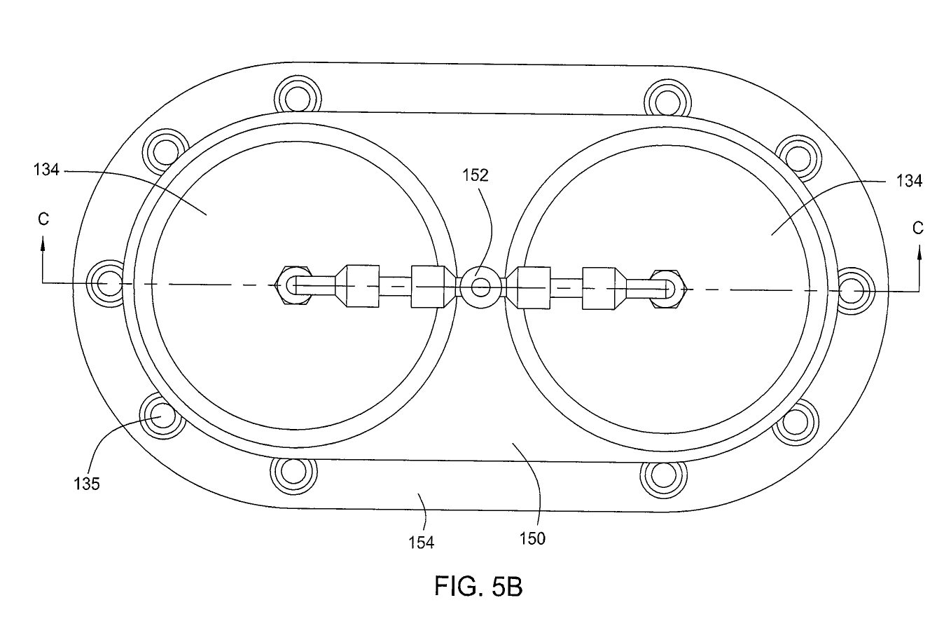

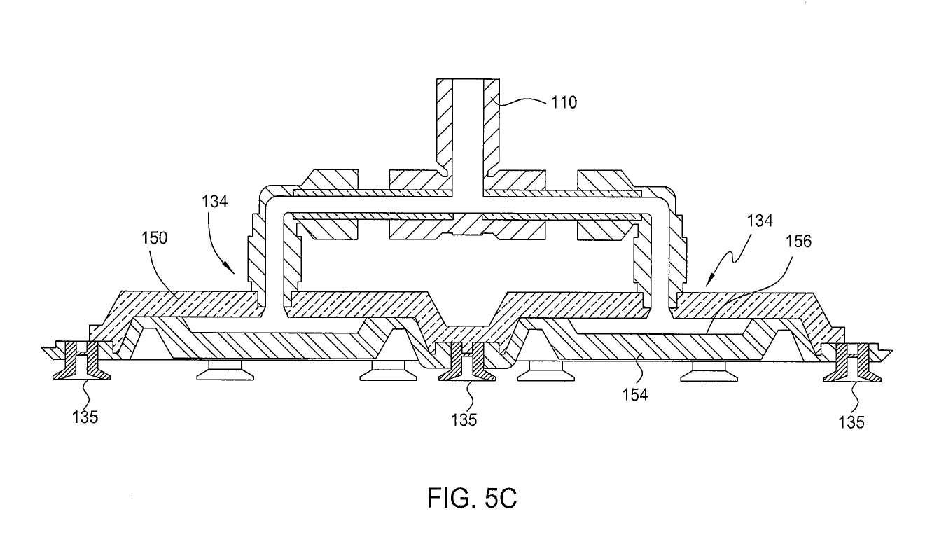

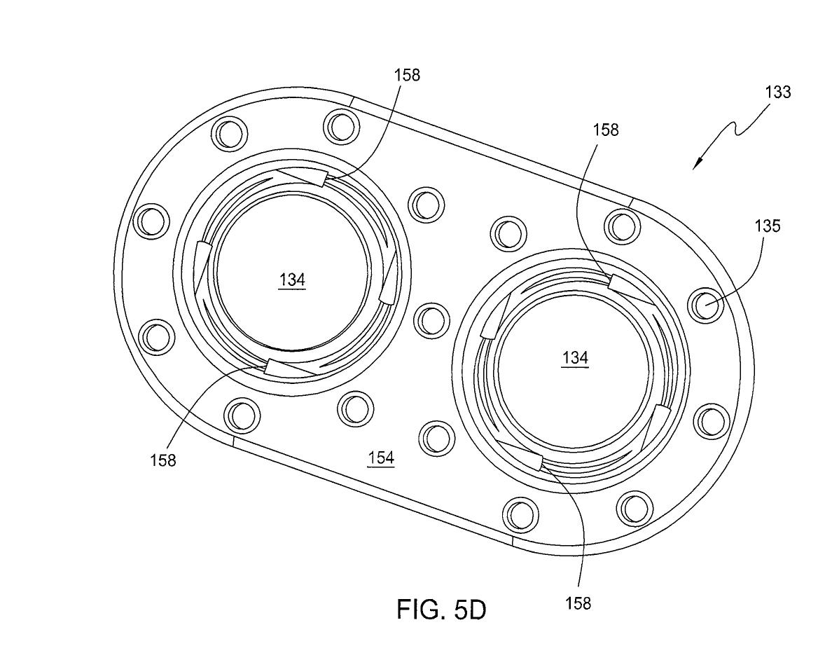

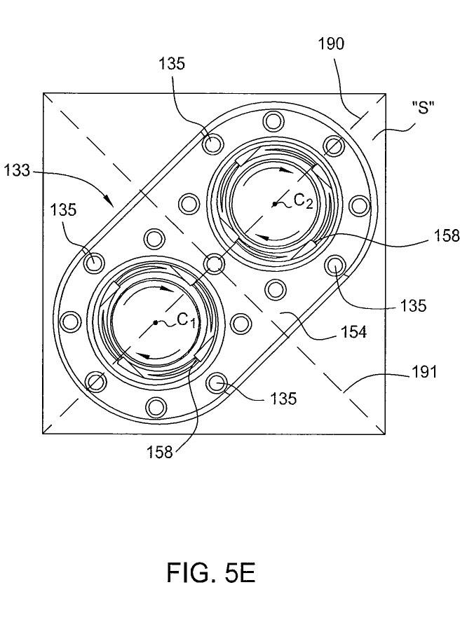

FIG. 5A is a schematic, isometric view of another embodiment of the end effector 133 illustrating the upper side, or non-substrate receiving side, of the end effector 133. FIG. 5B is a schematic, top view of the end effector 133 depicted in FIG. 5A. FIG. 5C is a schematic, cross-sectional view of the end effector 133 taken about line C-C depicted in FIG. 5B. FIG. 5D is a schematic, isometric view of the end effector 133 in FIG. 5A illustrating the underside, or substrate receiving side, of the end effector 133. FIG. 5E is a schematic, bottom view of the end effector 133 in FIG. 5A illustrating the positioning of a substrate S held thereby. In order to illustrate both the positioning of the substrate S underneath the end effector 133 as well as the components of the end effector 133, the substrate S is depicted as being transparent. It should be noted that although FIG. 5E depicts the substrate S atop the underside of the end effector 133, in operation the end effector 133 would be oriented with the substrate S below the underside of the end effector 133, as shown in FIG. 3.

In one embodiment, the end effector 133 is configured in a dual Bernoulli chuck configuration as shown in FIGS. 5A-5E. In this embodiment, the end effector 133 includes an upper portion 150 having an air inlet 152 fluidly connected with each Bernoulli chuck 134. In one embodiment, the first air control valve 136, in conjunction with the system controller 101, generally controls the air flow to the air inlet 152, which is then split into each Bernoulli chuck 134.

In one embodiment, the end effector 133 further includes a lower portion 154. The lower portion 154 and the upper portion 150 may be configured such that a plenum 156 is formed therebetween within each Bernoulli chuck 134. In one embodiment, the lower portion 154 includes a plurality of air outlets 158 configured to circulate airflow from each Bernoulli chuck 134. In one embodiment, the air outlets 158 are configured to cause circular air flow in opposing directions in order to prevent rotation of the substrate S as depicted by the arrows in FIG. 5E. For example, the airflow generated through one Bernoulli chuck 134 may be configured to circulate in a clockwise direction, while the air flow generated through the other Bernoulli chuck 134 is configured to circulate in a counterclockwise direction.

In one embodiment, the Bernoulli chucks 134 are configured to pick up and hold a substrate S such that the center points C1, C2 (FIG. 5E) of the Bernoulli chucks 134 are intersected by a diagonal 190 connecting one set of opposing corners of the substrate S, as shown in FIG. 5E. Concurrently, a diagonal 191 connecting the other set of opposing corners of the substrate S may bisect the Bernoulli chucks 134, as shown in FIG. 5E.

In one embodiment, the dual Bernoulli chucks 134 cover between about 20% and about 70% of a surface of a substrate S. In one embodiment, the dual Bernoulli chucks 134 cover between about 40% and about 60% of a surface of a 125 mm×125 mm pseudo-square substrate and between about 25% and about 35% of a surface of a 156×156 mm square substrate. Since, the dual Bernoulli chucks 134 cover such a large area of the substrate S, the gripping force is maximized without imparting detrimental stresses into the body of the substrate.

In one embodiment, the end effector 133 includes between about 4 and about 15 suction cups 135 to both to cushion and provide lateral support to the substrate S gripped by the dual Bernoulli chucks 134, as shown in FIGS. 5A-5E. The suction cups 135 may be evenly distributed surrounding the dual Bernoulli chucks 134 in order to prevent bowing in the ultra-thin substrate S, while being gripped by the Bernoulli chucks 134. In one embodiment, the suction cups 135 are configured in the general shape of a bellows to provide additional cushioning to the substrate S, particularly during retrieval of the substrate S. Additionally, the suction cups 135 prevent the substrate S from moving into a region of air flow next to the Bernoulli chucks 134 that can cause detrimental fluttering of the substrate S. Thus, the suction cups 135 provide stability and cushioning to the substrate S without the detrimental drawbacks of traditional methods of stabilizing a substrate on a Bernoulli chuck.

In certain embodiments, due to the properties of the material that the suction cups 135 are made from, such as synthetic rubber materials, elastomeric materials, or other polymeric materials, the substrate S may momentarily “stick” to the suction cups 135 during release of the substrate S. This “sticking” requires the robot 130 to momentarily hesitate to safely position the substrate S before moving back to the incoming conveyor to retrieve the next substrate. In one embodiment, the second air control valve 137 is in fluid communication with the suction cups 135. The system controller 101 may signal the air control valve 137 to provide light positive air pressure through the suction cups 135 to facilitate release of the substrate S. This feature may prevent “sticking” of the substrate S on the suction cups 135 during release of the substrate S, allowing the robot 130 to move to retrieve another substrate without hesitation. Thus, this feature facilitates significantly improved substrate throughput over time.

Therefore, embodiments of the present invention provide substrate handling system including a robot with an end effector capable of quickly and precisely transferring ultra-thin solar cell substrates while minimizing substrate damage and improving overall substrate throughput in a solar cell production line.

While the foregoing is directed to embodiments of the present invention, other and further embodiments of the invention may be devised without departing from the basic scope thereof, and the scope thereof is determined by the claims that follow.

1. An end effector for a substrate transferring robot, comprising:
one or more Bernoulli chucks;
a first air control valve in fluid communication with the one or more Bernoulli chucks; and
a plurality of suction cups disposed adjacent the one or more Bernoulli chucks, wherein the suction cups are positioned to extend below a lower surface of the one or more Bernoulli chucks.

2. The end effector of claim 1, further comprising a second air control valve in fluid communication with the plurality of suction cups, wherein the second air control valve is configured to provide only positive air pressure to the plurality of suction cups, and wherein each of the suction cups is in the general shape of a bellows.

3. The end effector of claim 2, wherein a bottom surface of the end effector comprises a reflective material.

4. The end effector of claim 2, further comprising a backlight for illuminating a bottom surface of the end effector.

5. The end effector of claim 1, comprising dual Bernoulli chucks having the plurality of suction cups surrounding the dual Bernoulli chucks, wherein the dual Bernoulli chucks are configured to hold a substantially square substrate positioned such that the center point of each of the Bernoulli chucks is in line with a diagonal line between opposite corners of the substrate.

6. The end effector of claim 5, further comprising a second air control valve in fluid communication with the plurality of suction cups, wherein the second air control valve is configured to provide only positive air pressure to the plurality of suction cups, and wherein each of the suction cups is in the general shape of a bellows.

7. The end effector of claim 6, wherein a bottom surface of the end effector comprises a reflective material.

8. The end effector of claim 6, further comprising a backlight for illuminating a bottom surface of the end effector.

9. A method for transferring a substrate, comprising:
maneuvering an end effector of a robot over the substrate;
attracting the substrate toward the end effector via one or more Bernoulli chucks attached to the end effector;
laterally stabilizing the substrate via a plurality of suction cups;
maneuvering the end effector to a delivery position; and
releasing the substrate.

10. The method of claim 9, further comprising flowing air through the plurality of suction cups to create a light positive pressure during the releasing the substrate.

11. The method of claim 10, further comprising cushioning the substrate during the attracting the substrate via the plurality of suction cups.

12. The method of claim 11, wherein attracting the substrate further comprises positioning the substrate such that a center point of each Bernoulli chuck is aligned with a diagonal between two opposing corners of the substrate.

13. The method of claim 12, further comprising:
maneuvering the substrate over a vision system;
illuminating a front surface of the substrate; and
capturing an image of the substrate.

14. The method of claim 13, further comprising illuminating a surface of the end effector via a backlight.

15. A transfer robot, comprising:
an upper base portion;
one or more arm devices connected to the base portion; and
an end effector connected to the one or more arm devices, wherein the end effector comprises:
one or more Bernoulli chucks;
a first air control valve in fluid communication with the one or more Bernoulli chucks; and
a plurality of suction cups disposed adjacent the one or more Bernoulli chucks, wherein the suction cups are positioned to extend below a lower surface of the one or more Bernoulli chucks.

16. The transfer robot of claim 15, further comprising a second air control valve in fluid communication with the plurality of suction cups, wherein the second air control valve is configured to provide only positive air pressure to the plurality of suction cups.

17. The transfer robot of claim 16, wherein each of the suction cups is in the general shape of a bellows.

18. The transfer robot of claim 17, wherein the end effector comprises dual Bernoulli chucks having the plurality of suction cups surrounding the dual Bernoulli chucks, and wherein the dual Bernoulli chucks are configured to hold a substantially square substrate positioned such that the center point of each of the Bernoulli chucks is in line with a diagonal line between opposite corners of the substrate.

19. The transfer robot of claim 18, wherein the end effector further comprises a backlight for illuminating a bottom surface of the end effector.

20. The transfer robot of claim 18, wherein a bottom surface of the end effector comprises a reflective material.
